(19) United States
(12) Patent Application Publication
(10) Pub. No.: US 2025/0180406 A1
(43) Pub. Date: Jun. 5, 2025

(54) SYSTEM AND METHOD FOR ANALYZING IGNITION-INDUCING PHENOMENA

(71) Applicant: Fagus-GreCon Greten GmBh & Co. KG, Alfeld (DE)

(72) Inventors: Michael Mehlhorn, Bad Gandersheim (DE); Mario Haas, Hildesheim (DE)

(21) Appl. No.: 18/844,295

(22) PCT Filed: Mar. 6, 2023
(86) PCT No.: PCT/EP2023/055625

§ 371 Date: Sep. 5, 2024

(30) Foreign Application Priority Data
Mar. 7, 2022 (DE) 10 2022 105 306.7

(51) Int. Cl. G01J 5/00; G01J 3/36; G01J 3/42

(52) U.S. Cl. CPC G01J 5/0018; G01J 3/36; G01J 3/42; G01J 5/0066

(57) ABSTRACT

A system and a method for analyzing ignition-inducing phenomena that occur in a reservoir which is loaded with media or through which media flow. The system and method allows the identification and risk evaluation of ignition-inducing phenomena in relation to a certain medium to be improved.

The present invention relates to a system and method for the analysis of ignition-inducing phenomena occurring in a media-loaded or media-throughflow reservoir. The system and method proposed by the invention adopts as its own an analysis of absorption phenomena which can occur as a result of a radiation emission by ignition-inducing phenomena.

Media-loaded or media-throughflow reservoirs are used in the most diverse industrial sectors, for example for the transport, storage, intermediate storage or processing of media.

A “medium” can include one or more components. In the present case, a “medium” can be understood to mean in particular solids, solid particles, dust particles, etc. If such substances or particles are moved, in particular at pressure values that are raised or lowered compared to normal pressure, the risk of the occurrence and thus also the danger of a flame formation, a fire or an explosion (e.g. a dust explosion) rises—in the presence of an ignition-inducing phenomenon. The same can apply to a static (not actively moving) storage of media (e.g. under pressure) in a reservoir. This is because even when a reservoir is “loaded” with a medium, (local) movements can be generated within the medium (e.g. due to pressure fluctuations, temperature gradients or due to certain material properties) which, in connection with an ignition-inducing phenomenon, can lead to an increased ignition or explosion hazard. Situations can also arise in which a glowing ember falls into a layer of dust or is transported into a silo. Dangerous mixtures of substances can form with regard to a potential risk of ignition or explosion, especially in connection with atmospheric oxygen. Likewise, fluids such as gases or liquids can also be understood as “medium” in the context of the present invention. Pasty or viscous media (e.g. plastic in a (partially) melted or softened or deformable state) are also possible media.

A “media-loaded” reservoir can be understood, for example, as a container (e.g. a silo or a storage container) loaded with a solid bed, a particle bed or a granulate bed, in which the medium is stored without active transport (i.e. without active induction of movement).

A “media-throughflow reservoir” can be understood to mean an (at least partially) outwardly closed conveying path, a conveying line, a conveyor belt, a chute, a filter, a filter system or a conveying channel, in which a media flow of a medium is present and a medium is transported (e.g. mechanically, pneumatically or otherwise). In a media-throughflow reservoir, the medium is thus present primarily in a moving state. Depending on the type of medium, the flow rate of the medium, and the shape and size of the reservoir, medium movements can cause, for example, turbulence (particularly in the case of a turbulent flow), local particle accumulations, deflagration, etc., all of which can lead to increased friction between particles belonging to the medium with one another, as well as between the particles and the walls of the reservoir. This can be associated with an increased development of frictional heat. An increased risk of ignition or explosion can therefore arise from ignition sources generated by the movement of the media (as ignition-inducing phenomena) or due to other ignition-inducing phenomena.

Such media storage or media movement occurs particularly frequently in manufacturing, processing or transport processes in the woodworking industry, the textile industry, the furniture industry, the coal industry, the paper industry, the plastics industry, the metal industry, the food industry, the luxury food industry (especially the tobacco industry), the animal feed industry, the leather industry, the rubber industry, the chemical industry and in black powder and fire additives industry. Plant for grinding or comminuting solids or solid mixtures, drying plant, cooling plant, compression plant, all of their pneumatic or mechanical transport and suction paths, are often to be found in the industrial fields mentioned. Dust extraction can also be understood as a media movement.

The previously mentioned areas of application or examples of application have in common an increased risk of fire, conflagration or explosion due to the interaction of ignition-inducing phenomena and the medium contained in an associated reservoir. This may be the case if fine particles of combustible (e.g. organic) material are present or are being moved in a reservoir in a high particle density. If an ignition-inducing phenomenon then occurs in a part of the plant or machine connected to the reservoir or in the reservoir itself, this can lead to the above-mentioned spark formation together with an accompanying ignition of the medium (up to an explosion). This can be intensified by the above-mentioned movement-induced turbulence, deflagration and heating effects of the media particles. Dust explosions can occur, for example, if ignition-inducing phenomena (as an ignition source), a suitable fuel (e.g. the specified medium in the form of dust) and oxygen are present in sufficient quantities. Ignition-inducing phenomena can result, for example, from hot surfaces, flames and hot gases, mechanically generated sparks, electrostatic discharges, glowing embers, electrical systems or burning metal particles.

In order to detect ignition-inducing phenomena early and thus to contribute to an effective fire, conflagration or explosion prevention, metrological devices for the (optical) detection of such ignition-inducing phenomena are used, which are also referred to in technical jargon as spark sensors or spark detectors. Spark detectors can be embedded in system-integrated alarm or extinguishing systems, or they can be used uncoupled from an alarm or extinguishing system, for example exclusively for monitoring a media-throughflow or media-loaded reservoir.

Ignition-inducing phenomena can be detected at an early stage by means of a spark detector, but this alone does not prevent a hazardous situation potentially arising therefrom (e.g. a fire or an explosion). Effective prevention can only take place if ignition-inducing phenomena detected by a spark detector are assessed in relation to the probability of triggering an actual hazardous situation (e.g. a fire or an explosion), i.e. with regard to their potential risk of triggering a fire or an explosion, so further steps can then be taken to eliminate the hazard—if necessary. Finally—if the ignition-inducing phenomena are not expected to come to an end independently—an extinguishing process must be started or the plant switched off in order to effectively fight or prevent a fire or an explosion. It is also necessary to inform people in the vicinity of such a plant about such a dangerous situation, so that they can get to safety. For this purpose, spark detectors are often coupled with suitable alarm systems, extinguishing systems or switch-off systems.

In order to observe ignition-inducing phenomena, a suitable measuring arrangement (e.g. as part of a spark detector) can be installed in a wall of the reservoir or can be arranged close to a radiation-transparent pane of a reservoir (e.g. a pipeline or a duct), in such a way that ignition-inducing phenomena within a volume element of the reservoir (i.e. an observation space) can be detected—e.g. optically—with the aid of the measuring arrangement. Optical detection is to be understood as the detection of electromagnetic radiation emitted by the ignition-inducing phenomena.

If an ignition-inducing phenomenon is detected, this can for example be passed on to an extinguishing centre, whereupon an extinguishing device can be activated in the reservoir using an automatic extinguishing system. Similarly, simply triggering of an alarm can contribute to extinguishing the source of the fire or explosion manually. A plant shutdown can also be a consequence of the detection of an ignition-inducing phenomenon.

A detector for the detection of sparks, fire and glowing embers is known from DE 20 2013 006 142 U1, which can detect flashes of light in the visible spectral region or alternatively thermal radiation in the infrared spectral region. For this purpose, the detector is inserted into a pipe wall with a socket having a translucent pane. The electromagnetic radiation to be detected is guided to a photo-sensitive element of the detector via a light guide arranged under the pane. The detected signals can then be evaluated.

However, since panes of this type become soiled and can thus impair a reliable detection of sparks, fire and glowing embers, arrangements and methods with which such soiling can be detected at an early stage have been identified in the prior art.

Thus, a method is known from WO 03/012381 A1, in which two diametrically opposed detectors used in a pipe wall are provided. To check the functional reliability of the detector, a test signal is emitted from a transmitter of one detector, which is at least partially picked up by a receiver of the opposite detector. Conclusions can be drawn from this regarding the functional reliability of the detector. The disadvantage, however, is the need for the diametrically opposed arrangement of two spark detectors. Accordingly, the provision of such a system is associated with increased costs and increased installation effort.

Publication DE 10 2017 005 386 A1 attributable to the applicant of the present invention is directed towards a method for monitoring a material flow in a pipeline, which uses at least one detector with a translucent pane, wherein at least one light-sensitive sensor is arranged beneath the translucent pane. The detector can detect sparks, fire or glowing embers in at least a first spectral region and can detect soiling of the pane in a second spectral region of a shorter wavelength which is spaced apart from the first.

Apart from guaranteeing a basic functionality of a spark detector, it is of particular importance for the above-mentioned applications to ensure sufficient functional reliability and measurement precision. It is of particular interest to avoid false alarms completely if possible and to enable a situation- or media-adapted detection of ignition-inducing phenomena.

The avoidance of false alarms is of enormous importance, since an alarm can often be accompanied by the shutdown of machines, plant or even an entire production shop. Furthermore, machines or plant can be damaged by the use of extinguishing agents. If it is a false alarm, unnecessary costs, damage, etc. may thus be incurred.

As already mentioned at the outset, a media particle density present in the reservoir at a certain point in time, the type and nature of the medium or an environmental parameter (e.g. temperature or pressure) can affect the probability of the generation of ignition-inducing phenomena (and a possible fire or explosion event arising therefrom). It is of great interest to consider such situation- or media-related parameters when making the hazard assessment of measurement data obtained with a spark detector. This is because not every ignition-inducing phenomenon detected with a spark detector also creates a risk of fire or explosion arising. With certain media, it can be normal or even desirable for ignition-inducing phenomena to occur—up to a certain extent—in a reservoir through which the medium flows or in a reservoir which is loaded therewith.

Furthermore, with spark detectors and associated alarm systems, there is a particular need for a situation- and media-adapted performance setting of the spark detectors, on the one hand to increase their measurement precision, on the other hand to avoid blind spot measurements, i.e. to avoid fire-like phenomena occurring in certain wavelength regions from being unable to be detected due to a lower measurement sensitivity in a certain spectral region.

A significant influencing factor that can affect the measurement accuracy (and thus reliability) when detecting ignition-inducing phenomena using spark detectors is a possible absorption of the (electromagnetic) radiation emitted by the ignition-inducing phenomena by an absorption medium present in the reservoir. The absorption medium can be formed, for example, by the medium flowing through the reservoir or with which the reservoir is loaded (e.g. in the form of organic dusts). Let us assume that a measuring arrangement suitable for detecting the radiation emitted by the ignition-inducing phenomena is arranged in a fixed position relative to the ignition-inducing phenomena occurring in the reservoir (the phenomena, however, may be subject to a movement relative to the measuring arrangement). The electromagnetic radiation emitted by the ignition-inducing phenomena is attenuated (weakened) according to the Lambert-Beer law. The absorption depends, among other things, on the medium that attenuates the signal intensity (i.e. on the material) and on its concentration in the reservoir (in particular in the observation space of the measuring arrangement, i.e. in the radiation path between the ignition-inducing phenomenon and the measuring arrangement). Since such absorption phenomena are also wavelength-dependent, they often cannot be reliably detected with conventional spark detectors (without intelligent, wavelength-related measurement sensitivity adjustment) or are included in the assessment of measurement results. External parameters such as the size and shape of the reservoir, environmental conditions such as temperature, pressure, etc., or operating parameters of a superordinate plant or machine contained in the reservoir can also influence absorption. If such absorption phenomena are not taken into account, ignition-inducing phenomena may not be reliably detected.

The mentioned absorption medium is not to be understood at this point as contamination particles which, for example, can adhere to the spark detector or the measuring arrangement used in the system according to the invention or which can contaminate the same. Measures can be taken to differentiate between such contamination and the absorption medium present in the reservoir (the influence of which is taken into account according to the invention), which however are not the subject of the present invention. Any interfering influences caused by soiling are avoided. Such measures can be of a mechanical or metrological nature.

There is therefore a growing need to provide a reliable detection of ignition-inducing phenomena together with a reliable risk assessment in reservoirs loaded with media or through which media flow (with the risk of the occurrence of ignition-inducing phenomena), which takes into account the occurrence of absorption phenomena. Equally, there is a growing need for operators of plant or machines (including a reservoir which can be loaded with a medium or through which the latter can flow) to obviate the risks of an unreliable detection or risk assessment of ignition-inducing phenomena that are caused by absorption phenomena, before the plant/machine is commissioned or before the medium is changed, and possibly even in the plant/machine planning stage.

Accordingly, the problem of the present invention is to provide a system and a method for the analysis of ignition-inducing phenomena occurring in a media-loaded or a media-throughflow reservoir, wherein the detection and risk assessment of ignition-inducing phenomena is improved in relation to a specific medium.

To solve this problem, a system with the features of claim 1 and a method with the features of claim 20 are proposed.

It should be pointed out that the features listed individually in the claims can be combined with one another in any technically meaningful way and show further embodiments of the invention. The description also characterises and specifies the invention in particular in connection with the figures. It is expressly pointed out that the features described in connection with the system proposed with the invention can also be possible embodiments of a method proposed with the invention and vice versa.

It should also be pointed out that a conjunction “and/or” used herein, standing between two features and linking them to one another, is always to be interpreted in such a way that in a first embodiment of the subject-matter according to the invention only the first feature can be present, and in a second embodiment only the second feature can be present and in a third embodiment both the first and second feature can be present.

In the first place, the invention relates to a system for the analysis of ignition-inducing phenomena occurring in a media-loaded or a media-throughflow reservoir, comprising
an observation space, in which absorption by an absorption medium of electromagnetic radiation emitted by an ignition-inducing phenomenon or a radiation source mimicking the ignition-inducing phenomenon can be observed,
a measuring arrangement which is configured and arranged so as to
   record at least one first absorption value relating to the electromagnetic radiation absorbed in the observation space by the absorption medium in a first characteristic wavelength range,
   and to record at least one second absorption value relating to electromagnetic radiation absorbed in the observation space by the absorption medium in a second characteristic wavelength range,
wherein the absorption in the first characteristic wavelength range is based on a first absorption characteristic, and wherein the absorption in the second characteristic wavelength range is based on a second absorption characteristic,
test equipment which is set up to determine an absorbance from the at least one first absorption value and the at least one second absorption value.

As mentioned, the present invention relates to a system for the analysis of ignition-inducing phenomena occurring in a media-loaded reservoir or a media-throughflow reservoir. For an understanding of the terms “media-loaded”, “media-throughflow”, “medium”, “reservoir” and “ignition-inducing phenomenon”, reference is made to the preceding statements, which apply directly to the system and method according to the invention.

The following explanations regarding these terms supplement/extend the above information.

The system according to the invention initially comprises an observation space, in which absorption by an absorption medium of electromagnetic radiation emitted by an ignition-inducing phenomenon can be observed. The observation space can be a closed space separate from the reservoir, but equally it can also be a (non-closed) three-dimensional volume element arranged within the reservoir. A section or region of the reservoir can thus also be understood as an observation space. An observation space arranged within the reservoir can be observed optically from outside the reservoir, e.g. through an observation window transparent for radiation of certain wavelengths which can be integrated into a wall of the reservoir. Even if an observation space is provided separate from the reservoir (which can be constituted, for example, in the sense of an observation box), the observation space can be observed optically through an observation window integrated in a wall of the observation space. In both cases (observation space=part of the reservoir observation space=external to the reservoir), a measuring arrangement including (optical) measuring units can be integrated into a wall of the reservoir or observation space in such a way that the observation space can be observed optically with the measuring arrangement. The observation space is loaded with the medium (which can also be the absorption medium, but does not have to be) and/or the absorption medium or the latter flows through said observation space. The observation space is not limited to any particular geometry or shape.

A “system” can be understood to mean an object which can be composed of one or more physical and/or non-physical components. A system can comprise mechanical, electrical, metrological, data-processing, data communication or other functions. Furthermore, a system can include a housing, in which components belonging to the system can be arranged. Individual (separate) system components can also be arranged in respective (separate) housings. System components can be connected to one another mechanically, by a signal system and/or electrically.

Computing units, servers, communication means, software, computing routines, algorithms, communication interfaces, microcontrollers, computing or control boards and other functional components can also be components of a system or provide a system. Programs, applications, application software, software, routines, algorithms, etc. can be executed on a system or a system component. The measuring arrangement associated with the system according to the invention and the test equipment are to be regarded as components of the system. Test equipment and measuring arrangement can be structurally combined, but can also be arranged separately (in this case, however, preferably connected to one another by data communication technology).

Furthermore, the system according to the invention comprises a measuring arrangement which is designed and arranged in such a way as to record at least one first absorption value relating to the electromagnetic radiation absorbed by the absorption medium in the observation space in a first characteristic wavelength range, and at least one second absorption value relating to the electromagnetic radiation absorbed by the absorption medium in the observation space in a second characteristic wavelength range. The absorption in the first characteristic wavelength range is based on a first absorption characteristic, while the absorption in the second characteristic wavelength range is based on a second absorption characteristic.

The term “measuring arrangement” can be understood to mean that it can be an arrangement of several units designed to record measurement data (acquisition means). However, a measuring arrangement can also exclusively comprise a measuring unit. The measuring unit(s) per se can each have one or more measuring or sensor elements and can each provide “acquisition means”. The measuring unit(s) preferably comprise(s) at least one radiation-sensitive electrical component for detecting electromagnetic radiation emitted by the ignition-inducing phenomena. For example, this can be a photodiode or a photoresistor.

“Acquisition of an absorption value” (the at least one first absorption value and the at least one second absorption value are meant by this) can be understood to mean a direct measurement of radiation absorption, but also an indirect measurement of radiation absorption (both using a suitable acquisition means). In particular, an “indirect measurement” of the absorption can be understood to mean the measurement of a radiation intensity (the radiation emitted by an ignition-inducing phenomenon) or another measured value representing emitted radiation (by the measuring arrangement, i.e. acquisition means) together with the subsequent determination of an associated absorption value on the basis of the measured radiation intensity or the other measured value representing the emitted radiation. The absorption value can then be determined, for example, by adjusting or normalising the measured radiation intensity or the other value representing the emitted radiation to a calibration measurement (without absorption) or predefined comparison data (comparison curves, comparison values). Another mathematical determination is also conceivable. A determination of absorption values is made possible by the relationship transmission=1−absorption and thus absorption=1−transmission. In the present case, the absorption can include not only the pure absorption of radiation by particles, but also scattering processes of radiation striking the particles. Then, instead of the mentioned absorption, it is better to use the term extinction. The extinction is made up of: extinction=absorption+scattering. Accordingly, it should be emphasised that “absorption” can also be understood to mean “extinction” at every point in this description. Consequently, “absorption values” can also be “extinction values”, and an “absorbance/degree of absorption” can also be a “degree of extinction”. Taking this relationship into account, the absorption (or extinction) can be calculated from the radiation intensity arriving (and detectable) in the measuring arrangement after the radiation emitted by an ignition-inducing phenomena has passed (been transmitted) through the absorption medium (which can be formed by the medium) or the other value representing the emitted radiation. A radiation intensity can be understood to mean the maximum of the radiation detected within a specific wavelength range, and equally an average value of several measured radiation intensities within the respective wavelength range as well as an integral of a curve of radiation intensities over a specific wavelength range. In terms of measurement technology, the detected radiation intensity or the other value representing the emitted radiation can be unitless, but equally can also be reproduced by a proportional value, for example by electrical voltages detected in the measuring arrangement. The “acquisition of an absorption value” with an “acquisition means” is not necessarily to be understood as a pure measurement process, but rather can already include steps of data processing and/or data evaluation. Apart from the radiation intensity, other suitable measured variables can also be used as a basis for acquiring the absorption values. This can already take place in the measuring arrangement or the acquisition means associated with the measuring arrangement, e.g. the measuring arrangement can comprise data processing means such as a data processing unit in addition to a sensor system (metrological acquisition). To determine the absorbance, it is advantageous to determine two or more second absorption values. The determination of >1 first absorption values may also be advantageous.

In the “acquisition of an absorption value” (or the at least one first and the at least one second absorption value), the metrological “acquisition” (detection) of electromagnetic radiation emitted by the ignition-inducing phenomena using one or more acquisition means plays an important role. The radiation can be detected wavelength-selectively or in predetermined spectral regions, i.e. wavelength ranges (first characteristic wavelength range, second characteristic wavelength range). In this way, wavelength-dependent radiation intensities (e.g. in the form of spectral peaks) can for example be detected. As mentioned, “acquisition” can not only be understood to mean detection as such, but also (at least temporary) recording, i.e. recording or storage of the data. This can take place in the aforementioned acquisition means (e.g. a first and second acquisition means which detect radiation in different wavelength ranges). Measuring units (these can provide the acquisition means or be part of them) with photosensitive elements, e.g. photodiodes, are primarily used to detect the radiation emitted by the ignition-inducing phenomena. The radiation received there can be recorded in the form of generated voltages. The intensity value of the voltages can be proportional to the intensity of the radiation intensity present at a specific wavelength or in a wavelength range. Measurement data recorded in this way can undergo pre-processing in advance with regard to the determination of absorption values before a qualitative or quantitative evaluation is carried out. The recorded data (e.g. raw data) can be converted into a desired data format or data representation.

According to the invention, the system includes test equipment which is set up to determine an absorbance from the at least one first absorption value and the at least one second absorption value. The “absorbance” determined is preferably a material-dependent measure. An “absorption value” may be a physical parameter reflecting the measured or determined radiation absorption (by the absorption medium). The absorption value can be unitless or can have a physical unit. The absorption value can equally be a proportional parameter to the measured or determined radiation absorption (by the absorption medium). An “absorbance” can also be a physical parameter, but in particular a value that reflects absorption characteristics of a material (e.g. an absorption coefficient). An absorbance can optionally be calculated from an absorption value.

For example, if the medium contained in the reservoir directly provides the absorption medium, the absorbance may depend on the material of the medium or its material composition (i.e. its components), equally the absorbance may also depend on ambient conditions (e.g. temperature, pressure etc.). Accordingly, an in situ determination of the absorbance under the conditions actually present on site in the reservoir is of particular interest. If the absorption coefficient is known, this can be taken into account when setting the measurement sensitivities of a spark detector or when assessing the risk of the signals measured by the spark detector. Precise prediction of the absorbance prior to the use/commissioning of a reservoir with a specific medium can also be of paramount importance for reliable fire and explosion protection that is adequate for the situation. Accordingly, an experimental simulation of the absorption conditions present in a reservoir on a smaller scale (e.g. in vitro in the laboratory), an observation space external to the reservoir, can be useful. Parameters can then be deduced from this which should be taken into account in actual monitoring in-situ (e.g. in relation to the measurement sensitivity of a spark detector monitoring the reservoir or operating parameters of a plant).

The test equipment can be a computing unit and/or a routine, software or an algorithm stored on a computing unit. “Test equipment” can also be understood to mean a computing unit in combination with a routine, software or an algorithm. Test equipment can include one or more computing units and/or one or more routines, software programs or algorithms. Furthermore, the test equipment can be designed in the form of a microcontroller, equally a logic circuit, e.g. an FPGA or an ASIC. The test equipment can be connected to the measuring arrangement to form a structural unit, e.g. can be arranged in a common housing. Equally, the test equipment can be arranged external to the measuring arrangement. In this case, the measuring arrangement and the test equipment have a data communication connection, so that an exchange of data, signals and/or commands is enabled between the measuring arrangement and the test equipment. For this purpose, the measuring arrangement and the test equipment have suitable communication interfaces.

It is essential for the present invention that measurement sensitivity adjustments (e.g. of spark detectors) or operating parameter adjustments of a superordinate plant or machine, which includes the reservoir, can be made in a manner appropriate to the situation by the detection, enabled according to the invention, of the absorption situation actually present in a reservoir at a certain point in time regarding radiation (which is emitted by ignition-inducing phenomena) absorbed by an absorption medium.

Furthermore, the system according to the invention as well as the method can be used for the preventive investigation of ignition-inducing phenomena possibly arising in a media-loaded or media-throughflow reservoir with regard to possible absorption phenomena of the electromagnetic radiation emitted by the ignition-inducing phenomena that occur in the reservoir due to absorption media. In this case, a sample of the medium to be used can be subjected to a corresponding examination in an observation space arranged external to the reservoir (e.g. in a test laboratory). In the (external) observation space, the conditions of the medium (absorption medium) in the reservoir can then be experimentally simulated and absorption phenomena examined. In this way, even before a medium is loaded into or flows through a reservoir (e.g. before a plant is commissioned, before a reservoir is reloaded, etc.), measures can be taken that allow a reliable detection of ignition-inducing phenomena that takes account of potential absorption phenomena, together with an associated risk assessment. This can take the form, for example, of a corresponding calibration or setting (e.g. measurement sensitivity adjustment and/or threshold value adjustment) of spark detectors/fire detectors used to monitor the reservoir or a corresponding adjustment of certain operating parameters (e.g. quantity, concentration, flow quantity, flow rate, pressure, temperature and type of medium in the reservoir).

With such an intelligent assessment or experimental investigation of absorption phenomena actually or potentially occurring in the media-loaded or media-throughflow reservoir, not only are misjudgments/false alarms resulting from an incorrect setting of spark or fire detectors prevented (when absorption phenomena are potentially present), but appropriate protective measures can already be taken, before a reservoir is loaded with a medium or a medium flows through the reservoir, with which the risk of fire or explosion due to ignition-inducing phenomena can be reduced or their detection can be improved. For example, measurement sensitivities (of spark or fire detectors) or operating parameters can be preventively adapted to an individual case of application and the media- or environment-specific requirements associated therewith.

Ignition-inducing phenomena can—as mentioned at the outset—be hot surfaces, flames or hot gases, mechanically generated sparks, electrostatic discharges or glowing embers. “Ignition-inducing phenomena” can also result from electrical systems or burning metal particles. In the present context, and “ignition-inducing phenomenon” can therefore be understood to be an optically perceptible source (e.g. with the measuring arrangement), i.e. a source of radiation emission. Spark, flame or glowing phenomena can be subsumed under ignition-inducing phenomena, equally a particle at high temperature, i.e. a hot particle (so-called hot particle).

As mentioned, the invention relates of the absorption behaviour of electromagnetic radiation emitted by ignition-inducing phenomena due to absorption media in a “media-throughflow or media-loaded reservoir”. Apart from the definitions and explanations mentioned at the outset in respect of the terms “medium”, “media-loaded” and “media-throughflow” reservoir, reference is made to the following explanations. Accordingly, a “medium” (this can at the same time also form the absorption medium) can be understood to mean solids, solid particles, mixtures of different solids or mixtures of solid particles, dust particles, etc. The medium can comprise solid particles of different particle sizes. The medium can also contain liquid or gaseous components. A medium can also be understood to mean solids which at least partially change their aggregate state during transport, or which undergo changes in terms of their shape and/or consistency. It can also be a pasty, gel-like, viscous medium. In principle, it is also conceivable to use the present invention with media which are present in or are transported through the reservoir in a liquid or gaseous state, as long as ignition-inducing phenomena occur and the latter can be detected metrologically (optically). If such substances or particles are moved, especially at pressure values which are higher or lower than normal pressure, the risk of the occurrence of ignition-inducing phenomena increases and thus also the risk of a flame formation, fire or explosion (e.g. a dust explosion). This can be intensified by dirt, dust, foreign particles, metal particles brought in by machine or plant components, or even an immediate introduction of sparks which can propagate in the reservoir.

As already mentioned in the introduction, a reservoir “loaded” with a medium can be understood to mean, for example, a container (e.g. a silo or a storage chamber) loaded with a solid bed, a particle bed or a granulate bed, in which the medium is stored without active transport (i.e. without active motion induction). The same can apply to the other forms of media described above, which have an aggregate state that differs from a solid state.

A “media-throughflow” reservoir can be understood to mean a conveying path, a conveying line or a conveying channel (at least partially) closed to the exterior, in which a media flow of a medium is transported (e.g. mechanically or pneumatically). A conveying channel provided with a screw conveyor can also be regarded as a reservoir through which a medium flows. Likewise, a chute, a filter, a filter system or a conveyor belt can provide a media-throughflow reservoir. In a media-throughflow reservoir, the medium is thus primarily in a moving state. Depending on the type and nature of the medium, the flow rate of the medium, and the shape and size of the reservoir, local particle accumulations, deflagration, etc. can result on account of media movements, for example turbulence (especially in the case of a turbulent flow), which can lead overall to increased friction between particles belonging to the medium among one another and between the particles and walls of the reservoir. This can be associated with an increased development of frictional heat. This can be intensified by dirt, dust, foreign particles, metal particles brought in by machine or plant components or even a direct introduction of sparks, which can spread in the reservoir.

Overall, the present invention enables the detection and analysis of absorption phenomena in which electromagnetic radiation of an ignition-inducing phenomenon is absorbed by an absorption medium (which can be the medium) at a specific wavelength or in a specific wavelength range. The detection of dangerous ignition sources (despite radiation absorption) can be improved with the present invention (system and method), or it can be obviated by a prediction of radiation absorption phenomena and a detection of ignition sources possibly affected with the occurrence of such absorption phenomena. Based on knowledge of radiation absorption, measurement sensitivity adjustments or threshold value adjustments can be made in spark detectors, so that the reliable detection of ignition sources is ensured despite radiation absorption phenomena. Radiation absorption phenomena can also be predicted experimentally by means of the present invention even before a reservoir is exposed to a medium (e.g. before a plant with such a reservoir is commissioned), so that even before the reservoir is exposed to the medium, adjustments can be made to spark or fire detectors provided for monitoring the reservoir. The same applies to adjustments to operating parameters of the reservoir (or a plant or machine comprising the reservoir). Such an adjustment of operating parameters can lie in the selection of the medium, the concentration of the medium, the filling level of the reservoir, the flow rate of the medium, the temperature, the pressure, etc.

Further advantageous embodiments of a system according to the invention result from the features specified in the sub-claims and described below. Reference is also made below to the features listed in the sub-claims. The features described below can also be advantageous embodiments of a method according to the invention.

According to a first embodiment of the invention, both the first characteristic wavelength range and the second characteristic wavelength range can lie within the wavelength range of 100 nm-3500 nm, wherein the first characteristic wavelength range and the second characteristic wavelength range preferably do not overlap and are preferably separated by a threshold wavelength or a threshold wavelength range. The wavelength ranges, in which electromagnetic radiation emitted by the ignition-inducing phenomena is absorbed by the absorption medium or in which absorption characteristics are present, depend on the material. In the first characteristic wavelength range, there is an absorption characteristic different from in the second characteristic wavelength range. The absorption characteristic changes at the threshold wavelength or in the threshold wavelength range. It is indeed possible to find absorption characteristics of certain media by means of a literature search (e.g. absorption curves), but for many substances there are no conclusive data or the data are not sufficiently conclusive. In particular, such data do not exist for the sensors used in the field of spark detection technology. Furthermore, absorption curves known from the literature only inadequately reflect the conditions actually present in a reservoir. This is where the present invention provides a remedy.

In wavelength ranges from 100 nm-1500 nm, ignition-inducing phenomena (especially sparks), which have a temperature of >1000° C., can usually be detected with high signal intensity using conventional spark detectors. In longer wave wavelength ranges, i.e. for example >1500 nm, ignition-inducing phenomena can be detected in the temperature range of 300° C.-500° C. with higher signal intensity. This depends of course on the type of sensors used in the spark detectors.

According to a further embodiment of the invention, the measuring arrangement can comprise a first acquisition means which is set up to record an at least one first absorption value in the first characteristic wavelength range. The measuring arrangement can also comprise a second acquisition means, which is set up to record an at least one second absorption value in the second characteristic wavelength range. An acquisition of two or more second absorption values of the second characteristic wavelength range is advantageous. For the meaning of the term “acquisition means”, reference is made to the preceding description. The respective first or second acquisition means can, for example, in each case comprise one or more measuring unit(s) with which electromagnetic radiation emitted by the ignition-inducing phenomena can be measured and the absorption value determined therefrom. It is also conceivable that the absorption values are measured directly by measuring units associated with the acquisition means. The first acquisition means (or an associated measuring unit) is preferably optimised for detecting electromagnetic radiation in a wavelength range which coincides with the first characteristic wavelength range, includes the first characteristic wavelength range, or lies within the first characteristic wavelength range. The second acquisition means (or an associated measuring unit) is also preferably optimised for detecting electromagnetic radiation in a wavelength range which coincides with the second characteristic wavelength range, includes the second characteristic wavelength range, or lies within the second characteristic wavelength range. According to this embodiment, the measuring arrangement thus comprises two acquisition means which can detect electromagnetic radiation in different wavelength ranges. Correspondingly, the first and second acquisition means can have their optimum sensitivity at different wavelengths.

According to a further embodiment of the invention, the measuring arrangement can have a single acquisition means which is set up to record the at least one first absorption value in the first characteristic wavelength range and to record the at least one second absorption value in the second characteristic wavelength range. For example, the single acquisition means (e.g. a single measuring unit) can detect or determine electromagnetic radiation or absorption values over a broad wavelength range, so that the first and second characteristic wavelength range lie (in each case at least partially) within a detectable wavelength range. Furthermore, the single acquisition means can comprise means with which an acquisition of the absorption values (directly or by measuring the radiation emitted by the ignition-inducing phenomena) in the respective characteristic wavelength ranges is enabled with sufficient sensitivity.

According to a further embodiment of the invention, the measuring arrangement can comprise a filter device which is set up to provide a first spectral filter state and a second spectral filter state, wherein acquisition of the at least one first absorption value in the first characteristic wavelength range by the acquisition means is enabled in the first spectral filter state, and wherein acquisition of the at least one second absorption value in the second characteristic wavelength range by the acquisition means is enabled in the second spectral filter state. This embodiment is particularly useful when use is made of a single acquisition means, which is sufficiently sensitive both in the first and in the second characteristic wavelength range. The filter device is a spectral filter, which can be constituted for example in the form of an exchangeable filter or a filter wheel.

According to a further embodiment of the invention, the measuring arrangement can comprise a filter device, in particular an exchangeable filter, which is set up to provide a number of >2 (e.g. 3, 4, 5, 6, 7, 8, 9 or 10) spectral filter states, wherein in the respective spectral filter state an acquisition of at least one first absorption value or at least one second absorption value by the acquisition means is enabled in sub-wavelength ranges of the first or second characteristic wavelength range. Such an embodiment enables the detection of a plurality of absorption values in the respective characteristic wavelength range, i.e. in sub-wavelength ranges relating thereto. A verification of characteristic absorption behaviour in the respective characteristic wavelength ranges can thus be verified. In this example of embodiment, too, it can be a filter wheel as an alternative to the exchangeable filter. It is possible to constitute the filter device in the sense of a magazine with a plurality of filters. Switching between filters of different spectral sensitivity can be done manually or automatically.

According to a further embodiment of the invention, the measuring arrangement can be part of a spark detector, wherein the measuring arrangement can provide an absorption spectrometer integrated into the spark detector. The spark detector can, for example, comprise a first measuring unit and a second measuring unit (possibly further measuring units). The first measuring unit can be designed to detect electromagnetic radiation emitted by the ignition-inducing phenomena in a wavelength range of 100 nm-1500 nm, and preferably of 750 nm-1200 nm, wherein the measurement sensitivity optimum of the first measuring unit is preferably in a wavelength range of approximately 950 nm, more preferably exactly 950 nm. The first measuring unit can preferably comprise a Si-based measuring element, for example an Si-based semiconductor, which can be part of a photodiode. Provision can also be made such that the first measuring unit comprises a plurality of Si-based measuring elements. The first measuring unit can have a particularly pronounced sensitivity (sensitivity) to ignition-inducing phenomena (in particular sparks) with a temperature of >1000° C. The first measuring unit can therefore be a conventional spark measuring unit. In the wavelength range of >1000 nm, the first measuring unit can have a lower measuring sensitivity. However, it is advantageous that the measurement signals recorded with the first measuring unit can be amplified relatively well. The amplification can take place via a classic analog or digital signal amplification (e.g. using an amplification module). Equally, however, an error threshold stored for the first measuring unit or a threshold value stored for triggering a danger signal can also be adjusted. The first measuring unit may only be weakly sensitive to electromagnetic radiation >1000 nm, but the measuring signal is amplified sufficiently, so that the signals recorded in this wavelength range with the first measuring unit with slight signal weakness can be amplified, in such a way that qualitative and/or quantitative information on the ignition-inducing phenomena—emitting electromagnetic radiation in this wavelength range—can be deduced from the amplified measurement data.

The second measuring unit can be designed to detect electromagnetic radiation emitted by ignition-inducing phenomena in a wavelength range of 1000 nm-3500 nm, preferably 1500 nm-3000 nm, and particularly preferably 2000 nm-2800 nm. The wavelength range accessible metrologically by the second measuring unit thus lies in a longer wave spectral region than the wavelength range of the first measuring unit. The second measuring unit preferably comprises a PbS-based measuring element, e.g. a PbS-based semiconductor, which can be part of a photodiode. Provision can also be made such that the second measuring unit comprises a plurality of PbS-based measuring elements. GaAs can also be used as a sensor material. The second measuring unit can be particularly well suited for the metrological acquisition of ignition-inducing phenomena in a temperature range of 300° C.-500° C. The second measuring unit can have a high sensitivity in the wavelength range mentioned, but the detected signals can have a relatively high noise component. The received signals can only be amplified slightly. The signal-to-noise ratios that can be achieved in the wavelength range mentioned are therefore rather low. If, for example, there are ignition-inducing phenomena which emit electromagnetic radiation in the second wavelength range, or if there are radiation absorption phenomena, the second measuring unit—due to the absorption of radiation—can become “blind” to a certain extent in the sensitive wavelength range, i.e. a metrological detection of the ignition-inducing phenomenon by the second measuring unit may be impaired. In such a case, however, such ignition-inducing phenomena can be detected by the first measuring unit—with a suitable measurement sensitivity adjustment. Accordingly, the knowledge of the occurrence of such absorption phenomena is of particular importance for a corresponding adjustment of the measurement sensitivity.

Optionally, the spark detector can comprise a third measuring unit which can be set up to detect electromagnetic radiation from ambient light in a wavelength range of 100 nm-500 nm. In particular, the third measuring unit can be set up to detect UV light (UV-A, UV-B, UV-C), i.e. to detect electromagnetic radiation in a wavelength range of 100 nm-380 nm. The third measuring unit can correspond to the first measuring unit, but without a filter restricting the detectable wavelength range. Correspondingly, the first measuring unit can comprise a filter. A filter which opens at a wavelength of 1500 nm can also be arranged on the second measuring unit. Ambient light can enter the reservoir through openings in the reservoir itself or through openings in an associated duct or line system. Light can also be generated by machine or plant components. Ambient light can disrupt the reliable detection of fire-like phenomena with the first and/or second measuring unit, but in particular the detection performance of the first measuring unit, since the wavelength range of ambient light lies in the range of the spectral region that can be detected by the first measuring unit. As a result of the presence of ambient light, the measurement sensitivity of the first and/or second measuring unit can be adjusted, in particular of the first measuring unit of the detector. Equally, provision can also be made for the first measuring unit to be switched off when there is ambient light, in order to avoid a measurement impairment in this regard. However, ambient light can also be determined on the basis of measurement data recorded with the first and/or second measuring unit, for example on the basis of the signal curve over time or the peak shape. Whereas ignition-inducing phenomena (e.g. sparks) always exhibit a peak shape changing in the time domain, the peak shape of stationary ambient light is unchanging or constant. Correspondingly, the presence of ambient light can be deduced from the signal curve of the measurement data recorded over time with the first and/or second measuring unit.

According to a further embodiment of the invention, the observation space can be arranged within the reservoir and form a volume element of the reservoir. If it is a measuring arrangement that has a spatially limited measuring field or measuring volume (field of view) for detecting electromagnetic radiation, the measuring arrangement has to be arranged in such a way that the measuring volume lies within the reservoir (forming an observation space there). In this case, the observation space is not a closed space, but part of the reservoir. The measuring arrangement can be integrated into a wall of the reservoir, positioned within the reservoir or arranged outside the reservoir (e.g. in the vicinity of a window of the reservoir). The window is preferably transparent for electromagnetic radiation. In the case of the design of the measuring arrangement in which it does not have a predetermined measurement volume, and all of the electromagnetic radiation striking the measuring arrangement is detected in the accessible wavelength range of the measuring arrangement, the reservoir provides the observation space in the area of the reservoir from which the radiation emitted from ignition-inducing phenomena can spread in the direction of the measuring arrangement and can be detected by the latter.

According to a further embodiment of the invention, the observation space can be arranged external to the reservoir and form an observation box. In this case, the observation space is not part of the reservoir; instead, a medium provided for the loading/throughflow of a reservoir can be examined externally with regard to absorption phenomena. For this purpose, the medium can for example be sent/handed over to a test centre (e.g. a laboratory). There, a sample of the medium can be filled into an observation box. With a view to certain boundary conditions, the loading can be adapted to the loading or throughflow situation that is actually present or to be expected in the reservoir. In this case the observation box is a closed space in the sense of a test chamber. However, “closed” does not necessarily mean a hermetically sealed space; rather, the observation box can comprise a filling opening for the medium to be tested. The observation box can also comprise a radiation-transmitting observation window, so that a measuring arrangement arranged outside of the observation box can be used to detect electromagnetic radiation that is generated and emitted by induction-inducing phenomena inside the observation box filled with the medium. The observation box can also comprise one or more walls that are transparent with respect to the electromagnetic radiation mentioned. The observation box can also be completely transparent, i.e. all walls are constituted transparent. The observation box can be a cuvette. The measuring arrangement can be integrated into a wall of the observation box, be positioned within the observation box or be arranged outside the observation box (e.g. in the vicinity of a window of the observation box). The window is preferably transparent for electromagnetic radiation. If the measuring arrangement does not have a predetermined measuring field and electromagnetic radiation striking the measuring arrangement is detected, the observation box provides the observation space in the section from which the ignition-inducing phenomena can be detected by means of the measuring arrangement.

According to a further embodiment of the invention, the observation box can form an analysis box in connection with the measuring arrangement. The analysis box can be portable, so that appropriate investigations of the absorption phenomena can be carried out, for example, on site at a customer's premises or in a laboratory. The measuring arrangement can form a common component arrangement with the observation box, e.g. the measuring arrangement (possibly the associated first and second acquisition unit) can be integrated into a wall of the observation box or attached thereto.

Provision can also be made to use a holder of a spark detector that is already arranged on a media-loaded or media-throughflow reservoir, in order to arrange an observation box and an analysis box thereon. The spark detector can provide part of the analysis box or form the latter. The spark detector can therefore provide part of the measuring arrangement.

According to a further embodiment of the invention, the test equipment can include a data processing unit. Furthermore, the test equipment can be connected to the measuring arrangement by means of data communication technology. The data processing unit can be the computing unit mentioned at the outset. Alternatively or in additional, a routine, software or an algorithm stored on the computing unit can be part of the test equipment. Correspondingly, the “test equipment” can also be understood as a data processing unit (computing unit) in combination with a routine, software or an algorithm. The test equipment can include one or more data processing units (computing units) and/or one or more routines, software programs or algorithms. Furthermore, the test equipment can be designed in the form of a microcontroller, as it were a logic circuit, e.g. an FPGA or an ASIC. Irrespective of whether the test equipment is connected to the measuring arrangement to form a structural unit, e.g. is arranged in a common housing or on a common circuit board, or whether the test equipment is arranged external to the measuring arrangement, the test equipment is connected to the measuring arrangement by means of data communication technology. For this purpose, the measuring arrangement or the test equipment can have suitable interfaces. The data communication connection can be wireless or wired. In any case, the measuring arrangement and test equipment have a data communication connection, so that an exchange of data, signals and/or commands is enabled between the measuring arrangement and test equipment.

According to a further embodiment of the invention, the test equipment can be set up to determine an absorption curve on the basis of the at least one first absorption value and the at least one second absorption value. According to a further embodiment of the invention, the first absorption characteristic can be a characteristic relating to a wavelength-dependent absorption curve in the first characteristic wavelength range. The characteristic related to the absorption curve can for example relate to a curve characteristic such as a curve shape, a gradient, an ordinate value, etc. According to a further embodiment of the invention, the second absorption characteristic can be a characteristic relating to a wavelength-dependent absorption curve in the second characteristic wavelength range. The characteristic related to the absorption curve can for example relate to a curve characteristic such as a curve shape, a gradient, an ordinate value, etc. According to a further embodiment of the invention, the first absorption characteristic can be a wavelength-dependent absorption curve essentially in the form of a plateau in the first characteristic wavelength range. A plateau can be understood in particular as a range with a gradient of zero, i.e. an ordinate value of the absorption curve is constant the first characteristic wavelength range. According to a further embodiment of the invention, the second absorption characteristic can essentially be a linear increase in the wavelength-dependent absorption curve in the second characteristic wavelength range. The absorption curve therefore has a gradient in this area. The gradient can—but does not have to—be constant. This relationship adopts the phenomenon that the absorption behaviour of absorption media is wavelength-dependent.

The determination of an absorption curve can be based on an approximation assumption, according to which the first absorption values are constant in the first characteristic wavelength range, i.e. assume constant values at different wavelengths (within the first characteristic wavelength range). In the second characteristic wavelength range, on the other hand, it can be assumed that the absorption curve (i.e. the second absorption values) is subject to a constant (wavelength-related) gradient. Even with the knowledge of a single first absorption value and two second absorption values, an approximate absorption curve can be determined by appropriate extrapolation. The absorption curve can also be determined from the knowledge of a first absorption value, a second absorption value and the threshold wavelength.

According to a further embodiment of the invention, the test equipment can be set up to determine an absorption coefficient as an absorbance on the basis of the linear increase. In particular, an absorption coefficient can be calculated from the gradient of the absorption curve in the second characteristic wavelength range. A wavelength-dependent measure of change of the absorption can also be determined on the basis of the gradient. For the determination of the absorption coefficient, the absorption curve can be represented non-logarithmically or logarithmically. In the first characteristic wavelength range, the absorption coefficient is independent of the wavelength and assumes a constant value. Knowledge of the wavelength-dependent absorption behaviour (absorption coefficient or measure of change in absorption) is of particular interest, since in this (second characteristic) wavelength range the electromagnetic radiation emitted by “hot” particles is absorbed to a not inconsiderable extent and it can therefore only be insufficiently detected using a spark detector. Therefore, the knowledge or prediction of the absorption behaviour of certain substances in relation to the monitored wavelength ranges is of particular interest in order to avoid misinterpretations of spark detectors.

According to a further embodiment of the invention, the test equipment can be set up to compare the determined absorbance with a predefined absorbance and, in the case of a determined absorbance exceeding a predetermined level in relation to the predefined absorbance, to output information relating to a critical absorption event, in particular to a warning unit, the spark detector or an extinguishing system. In the event that the absorption is so high that a reliable detection of ignition-inducing phenomena or a reliable risk assessment is no longer guaranteed, corresponding information about such a critical absorption event can be relayed to a warning unit, the spark detector or the extinguishing system. When this information is relayed to the spark detector, a sensitivity adjustment of the measuring units provided in the spark detector can be made as a result of the relayed information, alternatively or additionally a threshold value adjustment can be made. A recommendation can also be passed on to an operator of a plant to be monitored or od the spark detector to carry out an appropriate adjustment to the spark detector. The spark detector can thus be set up to carry out a sensitivity adjustment of the measuring arrangement (if the measuring arrangement is part of a spark detector) and/or one or more further measuring units as a result of receiving the information relating to the critical absorption event. If information is relayed to a warning unit, an optical or acoustic warning can be triggered (see the following description passages). If information is relayed to an extinguishing system, an extinguishing process can be triggered (see also the following description passages).

Said extinguishing system can be connected to the system according to the invention in terms of signalling technology and can comprise receiving means for receiving a signal transmitted by the system (e.g. danger signal). Using the extinguishing system, ignition-inducing phenomena in the media-throughflow or media-loaded reservoir can be extinguished using an extinguishing agent when the signal is received. When said signal is received, the extinguishing system can be activated to eliminate (i.e. extinguish) a hazardous condition. To extinguish the fire-like phenomena, an extinguishing agent can be introduced into the reservoir by the extinguishing system. The extinguishing agent can, for example, be a spray mist (of water or extinguishing foam).

Furthermore, the system can include a warning unit for raising optical and/or acoustic alarms if a dangerous situation occurs (e.g. as a result of a critical absorption event). As an alternative or in addition to the actuation of the extinguishing system, provision can thus be made for an alarm to be raised when a dangerous situation occurs. The triggering of an alarm may result in those in the vicinity of the reservoir being warned of a potential hazard. Furthermore, as a result of the alarm being raised, measures can be taken to eliminate the hazardous situation. The warning unit can comprise corresponding (optical, acoustic) alarm means for the optical and/or acoustic raising of the alarm. Optical alarm means can for example be signal lights, acoustic alarm means can be sirens or loudspeakers for example, via which an acoustic signal can be emitted. The provision of alarm means is advantageous in order to warn people in the vicinity of any danger or to guide auxiliary personnel or rescue or firefighting personnel to the location of the danger or the event.

The warning unit can be connected to the system according to the invention in terms of signal technology or be part of it. Furthermore, the warning unit can comprise reception means for receiving a danger signal triggered by the system.

If the observation space is arranged external to the reservoir, the observation space can be designed, for example, in the form of a cuvette or an observation box. The volume of the observation space can be variable. The observation space (e.g. the cuvette) can be filled with a medium which can provide the absorption medium. This can be made available for examination by a customer (e.g. an operator of a plant with a media-loaded or media-throughflow reservoir). Proceeding from a radiation source (this can, for example, be a blackened copper block that is heated with an infinitely variable oven), electromagnetic radiation can be radiated in the direction of the observation space which is loaded with the medium/through which the medium flows. The radiation source simulates an ignition-inducing phenomenon in relation to its radiation emission. The radiation passes through the observation space and is partly absorbed by the medium. Part of the radiation strikes a measuring arrangement with an intensity that is reduced by the absorption and can be detected there. A filter can be used between the radiation source and the observation space to block out ambient light. The radiation emitted by the radiation source can be spatially limited via an optional screen between the radiation source and the filter. The emitted radiation can be periodically shielded or released by means of a chopper (which can be arranged between the filter and the observation space). Alternatively, the radiation source can be modulated (i.e. switched on and off periodically). In this example, too, the measuring arrangement can be formed by a spark detector. The observation space is preferably transparent in at least two areas for the electromagnetic radiation generated by the radiation source, so that it can enter the observation space and exit in the direction of the measuring arrangement. Provision can be made for the radiation source to generate radiation of different wavelengths (e.g. a plurality of wavelengths within the first and second characteristic wavelength range). The radiation intensity arriving in the measuring arrangement present at these wavelengths (or another parameter) can then be recorded and an absorption value present at the respective wavelengths can be determined therefrom in comparison with a comparison measurement with an empty observation space (without any medium contained therein). The absorption at a specific wavelength can be determined by subtracting the radiation intensity detected at this wavelength with the measuring arrangement (with the absorption medium contained in the observation space, e.g. the medium) from a radiation intensity detected at this wavelength with the measuring arrangement (without a medium contained in the observation space). This can be done for at least one (preferably several) wavelengths in the first characteristic wavelength range and for at least one wavelength, preferably two or more wavelengths, in the second characteristic wavelength range. From this data, an absorption curve can be determined and an absorption coefficient of the medium can be determined. In this embodiment, the electromagnetic radiation emitted by ignition-inducing particles can be simulated by the radiation source. Instead of a wavelength-selective irradiation of the medium contained in the observation space, the radiation source can also emit broadband radiation. The spectral selection can then take place through the measuring arrangement, e.g. a filter device. The measuring arrangement can also be a spark detector in this embodiment.

In principle, it should be emphasised that if an observation space is provided external to the reservoir (e.g. in the sense of an observation box), the radiation emission of an ignition-inducing particle can be simulated (mimicked) by means of a radiation source. The radiation source is to be positioned in such a way that the electromagnetic radiation emitted by it can enter into the observation space.

Furthermore, the present invention relates to a method for analysing ignition-inducing phenomena occurring in a media-loaded or media-throughflow reservoir, wherein absorption by an absorption medium of electromagnetic radiation emitted by an ignition-inducing phenomenon or a radiation source mimicking the ignition-inducing phenomenon is observed in an observation space, wherein at least one first absorption value relating to the electromagnetic radiation absorbed by an absorption medium in the observation space is recorded in a first characteristic wavelength range using a measuring arrangement, wherein at least one second absorption value relating to the electromagnetic radiation absorbed by the absorption medium in the observation space is recorded in a second characteristic wavelength range using the measuring arrangement, wherein the absorption of the first characteristic wavelength range is based on a first absorption characteristic, and wherein the absorption in the second characteristic wavelength range is based on a second absorption characteristic, and wherein an absorbance is determined from the at least one first absorption value and the at least one second absorption value using test equipment.

According to an advantageous embodiment of the invention, the method can be carried out using a system according to the invention.

The method can be carried out continuously, at a preset time interval or at manually specified points in time.

Correspondingly, a periodic execution of the method, an aperiodic execution of the method or an execution of the method as and when required is enabled.

The features described above in connection with a system according to the invention can readily be understood as advantageous design features of a method according to the invention.

Furthermore, the present invention can relate to a method in which a sample of a medium intended for loading/flowing through a reservoir (e.g.) is provided by a customer. For this purpose, the sample can be taken from an existing reservoir or produced specifically for the analysis. This sample of the medium is then filled into an observation space (an observation box) external to the reservoir. The analysis method described above (the method according to claim 20) is then carried out, i.e. absorption by the absorption medium of electromagnetic radiation emitted by an ignition-inducing phenomenon or a radiation source mimicking the ignition-inducing phenomenon is observed in the observation space, wherein at least one first absorption value relating to the electromagnetic radiation absorbed by the absorption medium in the observation space is recorded in a first characteristic wavelength range using a measuring arrangement, wherein at least one second absorption value relating to the electromagnetic radiation absorbed by the absorption medium in the observation space is recorded in a second characteristic wavelength range using the measuring arrangement, wherein the absorption in the first characteristic wavelength range is based on a first absorption characteristic, and wherein the absorption in the second characteristic wavelength range is based on a second absorption characteristic, and wherein an absorbance is determined from the at least one first absorption value and the at least one second absorption value using test equipment.

Further features and advantages of the invention emerge from the following description of examples of embodiment of the invention, which are to be understood as not limiting and which are explained below by reference to the drawings. The drawing shows diagrammatically:

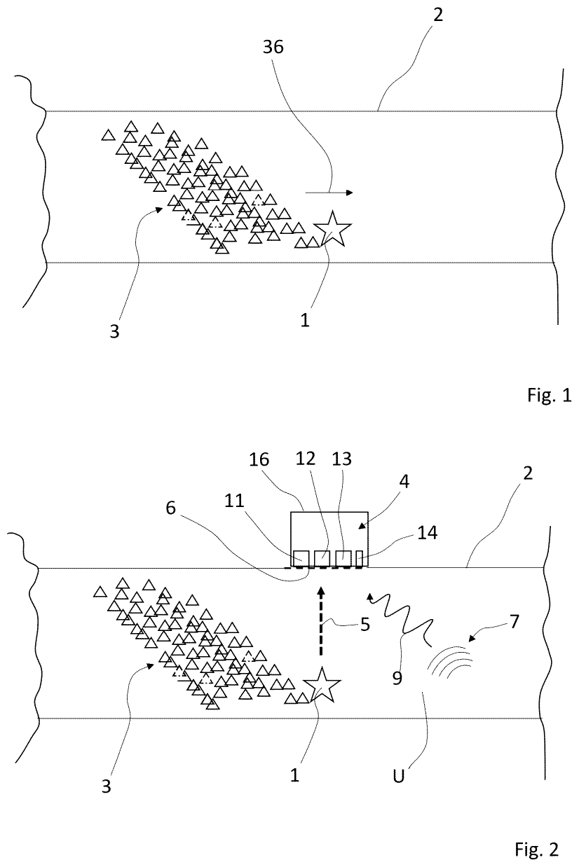

FIG. 1 a media-throughflow reservoir with an ignition-inducing phenomenon;

FIG. 2 an illustration of the basic functional principle of a spark detector when used in a media-throughflow reservoir according to FIG. 1;

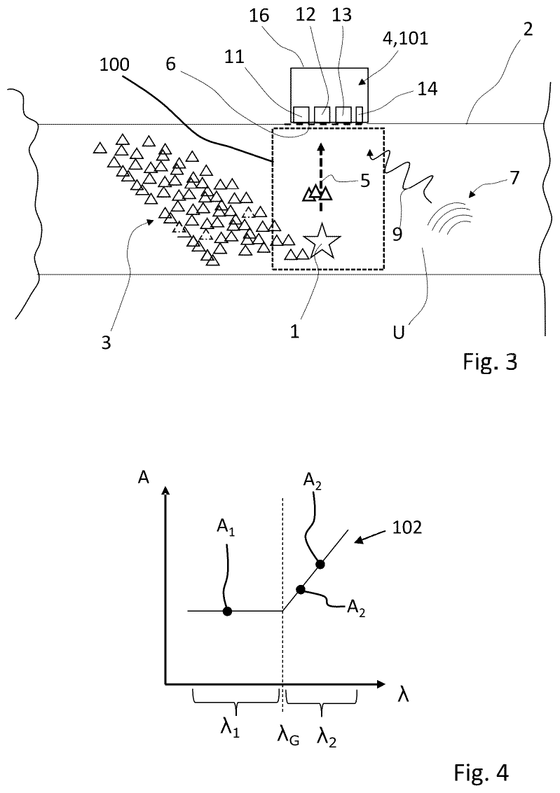

FIG. 3 a representation of a first example of embodiment of the system according to the invention when used in a media-throughflow reservoir according to FIG. 1 or 2, wherein the observation space belonging to the system is arranged inside the reservoir;

FIG. 4 a representation of a wavelength-dependent absorption curve;

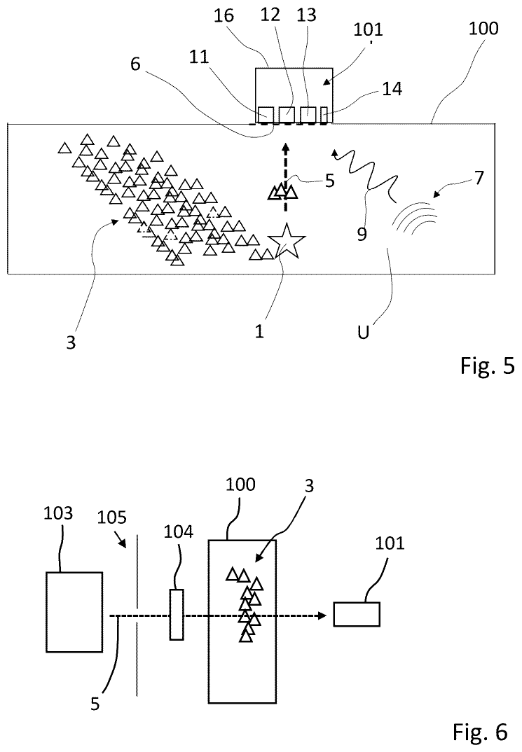

FIG. 5 a representation of a second example of embodiment of the system according to the invention, wherein the observation space belonging to the system is arranged externally not inside a reservoir, but external to the latter;

FIG. 6 a representation of a further example of embodiment of the system according to the invention, wherein the observation space belonging to the system is arranged not inside the reservoir, but external to the latter;

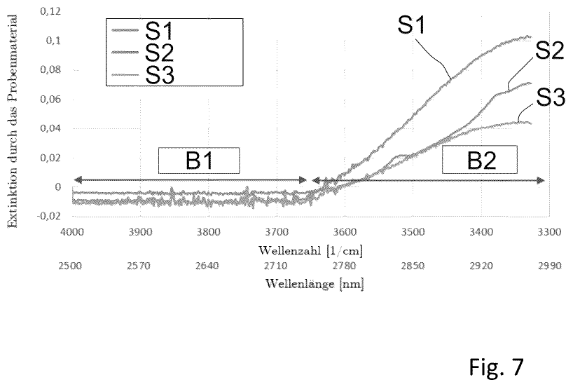

FIG. 7 a representation of extinction curves of three different substances recorded experimentally.

FIG. 1 represents a media-throughflow reservoir 2 as part of a superordinate production or processing plant in one of the branches of industry listed in the introductory description. Reservoir 2 is constituted as a channel (e.g. tubular) along which a medium 3 is conveyed, i.e. along conveying direction 36. Medium 3 is a solid which—as illustrated by the large number of triangular shapes shown—is present in particulate form. The transport takes place on the basis of gravity (e.g. when transporting in a vertical direction as in a downpipe), alternatively brought about mechanically or pneumatically. It is also recognised that ignition-inducing phenomena can occur in media-throughflow reservoir 2 (illustrated diagrammatically by a star shape). Ignition-inducing phenomena 1 can, under certain circumstances, act as an ignition source of a fire or even an explosion. It should be expressly emphasised that the invention can also be used with a media-loaded reservoir 2. The representation shown here of a media-throughflow reservoir 2 serves to illustrate the idea of the invention.

Spark detectors 4 can be used in order to recognise such ignition-inducing phenomena 1 at an early stage and to counteract the corresponding consequences. FIG. 2 illustrates the basic functional principle of such a spark detector 4. As can be seen, spark detector 4 comprises a sensor housing 16 in which a first, second and third measuring unit 11, 12, 13 and an optional sensor unit 14 are arranged. First measuring unit 11 is designed to detect electromagnetic radiation 5 (illustrated by a dashed arrow) emitted by ignition-inducing phenomena 1 in a first wavelength range. The first wavelength range extends from 190 nm-1100 nm, and preferably from 430 nm-1100 nm, wherein the measurement sensitivity optimum of first measuring unit 11 lies in a wavelength range of approximately 780 nm, preferably precisely 780 nm. Second measuring unit 12 is designed to detect electromagnetic radiation 5 emitted by ignition-inducing phenomena 1 in a second wavelength range. The second wavelength range lies at 1000 nm-3100 nm, and preferably extends from 1650 nm-3100 nm. The second wavelength range is therefore located in a longer wave spectral region.

Third measuring unit 13, on the other hand, is set up to detect electromagnetic radiation 9 from ambient light 7 in a wavelength range of 400 nm-700 nm. Ambient light 7 can enter reservoir 2 (or the channel) through openings in the reservoir or an associated channel system. Machine or plant components can also generate light, which provides a background light or ambient light 7 in reservoir 2. Furthermore, an (at least partially) optically transparent device 6 is provided in the area of the device or sensor arrangement 4 positioned on a wall of reservoir 2, e.g. a window through which radiation of specific wavelengths or specific wavelength ranges can pass. In this case, ambient light can, if necessary, also penetrate from the outside through device 6 into the interior of reservoir 2.

Sensor unit 14 optionally provided in spark detectors 4 is set up to record media-specific or environment-specific measurement data, for example a pressure, a density, a temperature, a humidity value, a particle concentration or a gas concentration of medium 3 or environment U of medium 3. These measurement data, which can be recorded with sensor unit 14, are optionally also taken into account in the risk assessment of an ignition-inducing phenomenon 1 recorded with measuring units 11, 12. Equally, the presence of ambient light 7 which can be detected with third measuring unit 13 is if necessary also included in the risk assessment. A spark detector 4 can also be configured differently and can, for example, only comprise one or two of the measuring units mentioned. The structure of spark detector 4 described here is of an exemplary nature.

FIG. 3 also shows a first example of embodiment of a system according to the invention. The system is designed to analyse ignition-inducing phenomena 1 occurring in a media-loaded or media-throughflow reservoir 2. In the present case, the system is explained using the example of a media-throughflow reservoir 2, but it can readily also be used with a media-loaded reservoir 2.

The system comprises an observation space 100 in which absorption by an absorption medium of electromagnetic radiation 5 emitted by an ignition-inducing phenomenon 1 can be observed. In the present case, the absorption medium is medium 3. According to this example of embodiment, observation space 100 is a volume element in media-throughflow reservoir 2. The system also includes a measuring arrangement 101, which is designed and arranged in such a way as to record at least one first absorption value A₁ relating to electromagnetic radiation 5 absorbed by the absorption medium in observation space 100 in a first characteristic wavelength range λ₁. This can be done with first acquisition means 201. The radiation absorption by medium 3 (which in this case provides the absorption medium) is characterised in FIG. 3 by three triangles, which cross the arrow representing electromagnetic radiation 5. Such radiation absorption leads to a weakening (attenuation) of the signal intensity that can be detected via measuring arrangement 101. Measuring arrangement 101 is also designed and arranged in such a way as to record at least one second absorption value A₂ relating to electromagnetic radiation 5 absorbed by the absorption medium in observation space 100 in a second characteristic wavelength range λ₂. This can be done with a second acquisition means 202. An acquisition of several second absorption values A₂ is advantageous. The system also includes test equipment (not shown), which is set up to determine an absorbance from the at least one first absorption value A₁ and the at least one second absorption value A₂. If spark detector 4 provides measuring arrangement 101, first measuring unit 11 can be regarded as the first acquisition means. Second measuring unit 12 can then be regarded as the second acquisition means.

The absorption in first characteristic wavelength range λ₁ is based on a first absorption characteristic, wherein the absorption in second characteristic wavelength range λ₂ is based on a second absorption characteristic. This connection is shown in absorption curve 102 reproduced in FIG. 4 (highly schematised) for a specific absorption medium. The absorption (unitless) is plotted on the y-axis against wavelength λ (on the x-axis). It was observed by the applicant that the absorption behaviour is wavelength-dependent. The absorption curve is thus divided into a first characteristic wavelength range λ₁ at lower wavelengths and a second characteristic wavelength range λ₂ at higher wavelengths. The wavelength ranges λ₁, λ₂ are separated by a threshold wavelength λ_{G}. The first absorption characteristic relates to absorption curve 102 in first characteristic wavelength range λ₁. As shown, absorption curve 102 has a plateau in first characteristic wavelength range λ₁, i.e. the gradient is equal to zero. The plateau shape of absorption curve 102 represents the first absorption characteristic. The second absorption characteristic relates to absorption curve 102 in second characteristic wavelength range λ₂. Absorption curve 102 displays a linear rise there. The absorption curve in the second characteristic wavelength range λ₂ can also have a gradient that deviates (varies) from a constant gradient. In contrast with the plateau of absorption curve 102 in first characteristic wavelength range λ₁, this can also be an indicator for the second absorption characteristic.

The test equipment mentioned is set up to determine absorption curve 102 mentioned on the basis of the at least one first absorption value A₁ and the at least one second absorption value A₂. The determination of absorption curve 102 can be based on an approximation assumption, according to which first absorption values A₁ are constant in first characteristic wavelength A₁, i.e. assume constant values at different wavelengths λ (within first characteristic wavelength range λ₁). In contrast, in second characteristic wavelength range λ₂, it can be assumed that absorption curve 102 (i.e. second absorption value A₂) has a constant (wavelength-related) gradient. Even in the knowledge of a single first absorption value A₁ and two second absorption values A₂, an approximate absorption curve can be created by appropriate extrapolation. Absorption curve 102 can also be determined from a knowledge of a first absorption value A₁, a second absorption value A₂ and the threshold wavelength λ₂. Threshold wavelength λ₂ and/or a number of second absorption values can be determined experimentally or be known from the literature. The more first and second absorption values A₁, A₂ are determined, the more precise is the determined absorption curve 102. An absorption coefficient of the absorption medium can be determined from the gradient of absorption curve 102 in second characteristic wavelength range λ₂.

In the example of embodiment according to FIG. 5, observation space 100 is arranged external to reservoir 2 and forms an observation box, so that the conditions present in the reservoir can be simulated on a laboratory scale. In this case, observation space 100 is a box (for simulating a static loading of a reservoir 2) which is filled with an absorption medium (here medium 3). Equally, observation space 100 can be designed in the manner of a flow channel in order to be able to simulate media-throughflow reservoirs 2 on a laboratory scale. Observation space 100 has an optically transparent device 6 (e.g. a window) through which electromagnetic radiation 5 emitted by ignition-inducing phenomenon 1 can pass in the direction of a measuring arrangement 101. Measuring arrangement 101 forms an analysis box with the observation box. For this purpose, measuring arrangement 101 is attached to the observation box. Measuring arrangement 101 can—but does not have to—be a spark detector 4.

The test equipment mentioned can be integrated into measuring arrangement 101 in both examples of embodiment of FIGS. 3 and 5. Equally, the test equipment can be arranged external to measuring arrangement 101 and can be connected to measuring arrangement 101 in terms of data communication.

FIG. 6 shows an alternative example of embodiment for an observation box arranged external to a reservoir 2. Observation space 100 forming the observation box can for example be constituted in the form of a cuvette. Observation space 100 (e.g. the cuvette) is filled with a medium 3 which provides the absorption medium. This can be made available for examination by a customer (e.g. an operator of a plant with a media-loaded or media-throughflow reservoir). Proceeding from a radiation source 103 (this can, for example, be a blackened copper block is heated with an infinitely variable oven), electromagnetic radiation 5 is emitted in the direction of observation space 100. Radiation 5 passes through observation space 100 and is partially absorbed by medium 3. Part of the radiation strikes measuring arrangement 101 with an intensity that is weakened by the absorption and can be detected there. A filter 104 can be used to block out ambient light. The radiation emitted by radiation source 103 can be spatially limited by an optional screen 105. The emitted radiation can be periodically shielded or released by means of a chopper (which can be arranged between filter 104 and observation space 100). In this example, too, measuring arrangement 101 can be formed by a spark detector.

Both in the example of embodiment according to FIG. 5 and also in the example of embodiment according to FIG. 6, observation space 100 can have a variable volume, so that the sample volume can be flexibly adjusted. In both examples of embodiment, observation space 100 can be completely or partially transparent for electromagnetic radiation 5. A design that is only partially transparent (only in those areas in which radiation has to enter and/or exit observation space 100) is advantageous in order to reduce the influence of extraneous light or ambient light.

FIG. 7 shows the absorption curve represented in abstract terms and schematised in FIG. 4 based on extinction curves determined experimentally for different substances S1 (cocoa powder), S2 (milk powder) and S3 (wood dust). As already illustrated in FIG. 4, the curve determined experimentally in FIG. 7 displays a constant absorption (here extinction) in a region B1 (first characteristic wavelength range), whereas in a region B2 an approximately constant increase in the extinction can be determined. In the region B1, the absorption/extinction is independent of the wavelength, whereas the absorption/extinction in the region B2 is wavelength-dependent.

### LIST OF REFERENCE NUMBERS/SYMBOLS

1 Ignition-inducing phenomenon
2 Reservoir
3 Medium
4 Spark detector
5 Electromagnetic radiation
6 Optically transparent device
7 Ambient light
9 Electromagnetic radiation (ambient light)
11 First measuring unit
12 Second measuring unit
13 Third measuring unit
14 Sensor unit
16 Sensor housing
30 Alarm system
31 Flame
36 Conveying direction
100 Observation space
101 Measuring arrangement
102 Absorption curve
103 Radiation source
104 Filter
201 First acquisition means
202 Second acquisition means
A₁ First absorption value
A₂ Second absorption value
B1 Region
B2 Region
S1 Cocoa powder
S2 Milk powder
S3 Wood dust
λ₁ First characteristic wavelength range
λ₂ Second characteristic wavelength range
λ_{G} Threshold wavelength
U Environment

1. A system for the analysis of ignition-inducing phenomena occurring in a media-loaded or a media-throughflow reservoir, comprising
an observation space, in which absorption by an absorption medium of electromagnetic radiation emitted by an ignition-inducing phenomenon or a radiation source mimicking the ignition-inducing phenomenon can be observed,
a measuring arrangement which is configured and arranged so as to
record at least one first absorption value (A1) relating to the electromagnetic radiation absorbed by the absorption medium in the observation space in a first characteristic wavelength range (λ1),
and to record at least one second absorption value (A2) relating to electromagnetic radiation absorbed by the absorption medium in the observation space in a second characteristic wavelength range (λ2),
wherein the absorption in the first characteristic wavelength range (λ1) is based on a first absorption characteristic, and wherein the absorption in the second characteristic wavelength range (λ2) is based on a second absorption characteristic,
test equipment which is set up to determine an absorbance from the at least one first absorption value (A1) and the at least one second absorption value (A2).

2. The system according to claim 1, wherein both the first characteristic wavelength range (λ1) and the second characteristic wavelength range (λ2) lie within a wavelength range of 100 nm-3500 nm, wherein the first characteristic wavelength range (λ1) and the second characteristic wavelength range (λ2) preferably do not overlap and are preferably separated by a threshold wavelength (λG) or a threshold wavelength range.

3. The system according to claim 1, wherein the measuring arrangement comprises a first acquisition means, which is set up to record at least one first absorption value (A1) in the first characteristic wavelength range (λ1), and wherein the measuring arrangement comprises a second acquisition means, which is set up to record the at least one second absorption value (A2) in the second characteristic wavelength range (λ2).

4. The system according to claim 1, wherein the measuring arrangement comprises a single acquisition means which is set up to record the at least one first absorption value (A1) in the first characteristic wavelength range (λ1) and the at least one second absorption value (A2) in the second characteristic wavelength range (λ1).

5. The system according to claim 4, wherein the measuring arrangement comprises a filter device which is set up to provide a first spectral filter state and a second spectral filter state, wherein acquisition of the at least one first absorption value (A1) in the first characteristic wavelength range (λ1) by the acquisition means is enabled in the first spectral filter state, and wherein acquisition of the at least one second absorption value (A2) in the second characteristic wavelength range (λ2) by the acquisition means is enabled in the second spectral filter state.

6. The system according to claim 4, wherein the measuring arrangement comprises a filter device, in particular an exchangeable filter, which is set up to provide a number of >2 spectral filter states, wherein an acquisition of at least one first absorption value (A1) or at least one second absorption value (A2) by the acquisition means in sub-wavelength ranges of the first or second characteristic wavelength range (λ1, λ2) is enabled in a respective spectral filter state.

7. The system according to claim 1, wherein the measuring arrangement is part of a spark detector, and wherein the measuring arrangement provides an absorption spectrometer integrated into the spark detector.

8. The system according to claim 1, wherein the observation space is arranged within the reservoir and forms a volume element of the reservoir.

9. The system according to any one of claim 1, wherein the observation space is arranged external to the reservoir and forms an observation box.

10. The system according to claim 9, wherein the observation box forms an analysis box in connection with the measuring arrangement.

11. The system according to claim 1, wherein the test equipment includes a data processing unit, and wherein the test equipment is connected to the measuring arrangement by means of data communication technology.

12. The system according to claim 1, wherein the test equipment is set up to determine an absorption curve on the basis of the at least one first absorption value (A1) and the at least one second absorption value (A2).

13. The system according to claim 1, wherein the first absorption characteristic is a characteristic relating to a wavelength-dependent absorption curve in the first characteristic wavelength range (λ1).

14. The system according to claim 1, wherein the second absorption characteristic is a characteristic relating to a wavelength-dependent absorption curve in the second characteristic wavelength range (λ2).

15. The system according to claim 13, wherein the first absorption characteristic is a wavelength-dependent absorption curve essentially in the form of a plateau in the first characteristic wavelength range (λ1).

16. The system according to claim 14, wherein the second absorption characteristic is essentially a linear rise of the wavelength-dependent absorption curve in the second characteristic wavelength range (λ2).

17. The system according to claim 16, wherein the test equipment is set up to determine an absorption coefficient as an absorbance on the basis of the linear rise.

18. The system according to claim 17, wherein the test equipment is set up to compare the determined absorbance with a predefined absorbance and, in the case of a determined absorbance exceeding a predetermined level in relation to the predefined absorbance, to output information relating to a critical absorption event, in particular to a warning unit, the spark detector or an extinguishing system.

19. The system according to claim 18, wherein the spark detector is set up to carry out a sensitivity adjustment of the measuring arrangement and/or one or more further measuring units as a result of receiving the information relating to the critical absorption event.

20. A method for analyzing ignition-inducing phenomena occurring in a media-loaded or media-throughflow reservoir, wherein absorption by an absorption medium of electromagnetic radiation emitted by an ignition-inducing phenomenon or a radiation source mimicking the ignition-inducing phenomenon is observed in an observation space, wherein at least one first absorption value (A1) relating to the electromagnetic radiation absorbed by the absorption medium in the observation space in a first characteristic wavelength range (λ1) is recorded using a measuring arrangement, wherein at least one second absorption value (A2) relating to the electromagnetic radiation absorbed by the absorption medium in the observation space in a second characteristic wavelength range (λ2) is recorded using the measuring arrangement, wherein the absorption in the first characteristic wavelength range (λ1) is based on a first absorption characteristic, and wherein the absorption in the second characteristic wavelength range (λ2) is based on a second absorption characteristic, and wherein an absorbance is determined from the at least one first absorption value (A1) and the at least one second absorption value (A2) using test equipment.

21. (canceled)
